(19) United States
(12) Patent Application Publication
(10) Pub. No.: US 2010/0083241 A1
(43) Pub. Date: Apr. 1, 2010

(54) IMAGE FORMING APPARATUS, DELIVERY SERVER, AND FIRMWARE UPDATING METHOD

(75) Inventor: Makoto Kobayashi, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/570,904

(22) Filed: Sep. 30, 2009

(30) Foreign Application Priority Data
Oct. 1, 2008 (JP) 2008-256012

(51) Int. Cl. G06F 9/44

(52) U.S. Cl. 717/168

(57) ABSTRACT

The present invention provides an image forming apparatus that includes a set value encryption section that acquires set values which have been set in current firmware and encrypts a part of the set values, a set value transmission section that transmits encrypted set values and unencrypted set values to a delivery server, a firmware acquisition section that acquires the new firmware, in which the encrypted set values and the unencrypted set values have been set, from the delivery server, a firmware update section that decrypts the encrypted set values and installs the new firmware; and an accepting section that receives instructions about the set value to be encrypted among the set values from the delivery server.

### BACKGROUND OF THE INVENTION

1. Field of the Invention

The present invention relates to an image forming apparatus that delivers a firmware via a network and updates the firmware, a delivery server, and a firmware updating method.

2. Description of the Related Art

Conventionally, as a system for updating firmware embedded into a device (device-embedded type firmware updating system), devices disclosed, for example, in Japanese Patent Laid-Open No. 2002-222068 and Japanese Patent Laid-Open No. 2003-196186 are known.

Japanese Patent Laid-Open No. 2002-222068 discloses an image forming apparatus that confirms the apparatus model and the current version of firmware and obtains information for the latest version of firmware corresponding to its model and other apparatus models from a central management apparatus for checking whether a version-upgrade is required. Next, if firmware corresponding to its model has been upgraded to a new version, the image forming apparatus downloads the firmware from the central management apparatus for a version upgrade. Subsequently, if firmware corresponding to other image forming apparatus model has been upgraded to a new version, the image forming apparatus downloads the firmware from the central management apparatus and transfers it to other apparatuses via a network for version upgrades.

Japanese Patent Laid-Open No. 2003-196186 discloses a management apparatus that transmits a control program (including script) with a description of a process to be executed at the image processing apparatus in order to perform an update process to a new firmware upon a new firmware transmission.

### SUMMARY OF THE INVENTION

According to an aspect of the present invention, a firmware delivery system and a firmware delivery method are provided that are capable of taking over setup information associated with current firmware to new firmware in a safe and reliable manner.

According to another aspect of the present invention, an image forming apparatus is provided that receives firmware from a delivery server and installs the firmware, the image forming apparatus comprising a set value encryption unit configured to acquire set values that have been set in the current firmware and encrypt a part of the set values; a set value transmission unit configured to transmit encrypted set values and unencrypted set values to the delivery server; a firmware acquisition unit configured to acquire new firmware, in which the encrypted set values and the unencrypted set values have been set, from the delivery server; a firmware update unit configured to decrypt the encrypted set value and install the new firmware; and an accepting unit configured to receive instructions about the set value to be encrypted among the set values from the delivery server.

According to yet another aspect of the present invention, a delivery server for delivering firmware to an image forming apparatus is provided that comprises a firmware storing unit configured to store a firmware; a set value accepting unit configured to accept encrypted set values and unencrypted set values from the image forming apparatus; a set value converting unit configured to convert the set values so as to be compatible with the new firmware; a firmware setting unit configured to set the set values that have been converted by the set value converting unit to the new firmware; a firmware delivering unit configured to deliver the new firmware, in which the set values have been set by the firmware setting unit, to the image forming apparatus; and an update instructing unit configured to provide instructions about the set value to be encrypted among the set values to the image forming apparatus.

Further features of the present invention will become apparent from the following description of exemplary embodiments with reference to the attached drawings.

### BRIEF DESCRIPTION OF THE DRAWINGS

FIG. 1 is a diagram showing the configuration of a firmware updating system according to the first embodiment.

FIG. 2 is a block diagram showing the configuration of an image forming apparatus according to the first embodiment.

FIG. 3 is a block diagram showing the configuration of the firmware update program for the image forming apparatus according to the first embodiment.

FIG. 4 is a block diagram showing the configuration of a delivery server according to the first embodiment.

FIG. 5 is a block diagram showing the configuration of the firmware update program of the delivery server according to the first embodiment.

FIG. 6 is a flowchart showing the sequence of firmware update processing performed by the image forming apparatus according to the first embodiment.

FIG. 7 is a flowchart showing the creation processing of export data performed by the image forming apparatus according to the first embodiment.

FIG. 8 is a flowchart showing the procedure of firmware update processing performed by the delivery server according to the first embodiment.

FIG. 9 is a flowchart showing the procedure of various set values conversion processing performed by the delivery server according to the first embodiment.

FIG. 10 is a diagram showing an example of encryption of user setting information according to the first embodiment.

FIG. 11 is a diagram showing an example of a user setting information schema before encryption according to the first embodiment.

FIG. 12 is a diagram showing an example of a user setting information schema after encryption according to the first embodiment.

FIG. 13 is a diagram showing an example of an expanded user setting information schema for the new firmware according to the first and the second embodiments.

FIG. 14 is a diagram showing the configuration of a firmware updating system according to the second embodiment.

FIG. 15 is a flowchart showing the procedure of firmware update processing performed by an image forming apparatus according to the second embodiment.

FIG. 16 is a flowchart showing the procedure of firmware update processing performed by a delivery server according to the second embodiment.

FIG. 17 is a diagram showing the configuration of a firmware updating system according to the third embodiment.

FIG. 18 is a flowchart showing the procedure of firmware update processing performed by an image forming apparatus according to the third embodiment.

FIG. 19 is a flowchart showing the procedure of firmware update processing performed by a delivery server according to the third embodiment.

### DESCRIPTION OF THE EMBODIMENTS

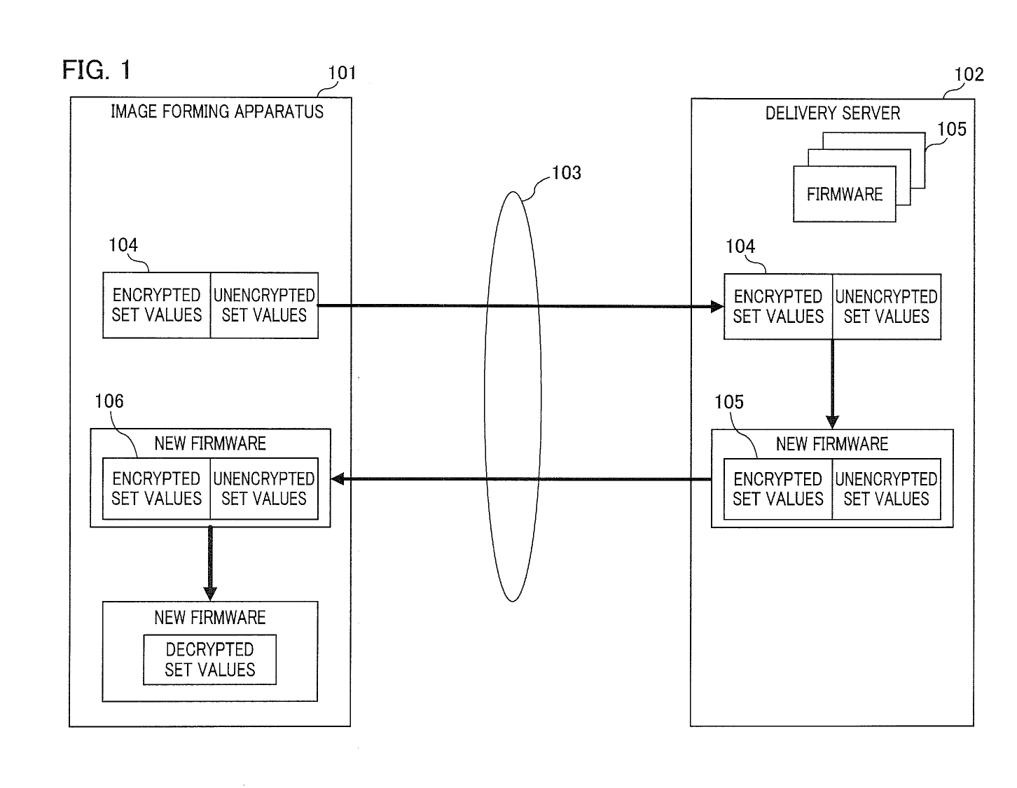

FIG. 1 is a diagram showing an example of the configuration of the firmware updating system according to the first embodiment. The firmware updating system of the first embodiment includes an image forming apparatus (for example, Multi Functional Printer) 101 which is an exemplary image forming apparatus. The firmware updating system also includes a delivery server 102 that is connected to the image forming apparatus 101 via a network 103. The image forming apparatus may be any other apparatus for storing a firmware, such as a personal computer, portable terminal, printer, or copier.

The image forming apparatus 101 stores firmware and set values in a ROM 202 or a HDD 203 to be described below. A user of the image forming apparatus 101 can make unique settings in various applications that are executed using the firmware of the image forming apparatus 101. An exemplary application through which a user can make unique settings is an E-mail transmission application for a print object. The E-mail transmission application for a print object holds an address book, in which mail addresses to be used for E-mail transmission are recorded, as a set value.

The delivery server 102 stores model-specific and version-specific firmware 105, and manages the firmware 105 using a database. The delivery server 102 searches the database, selects the appropriate version of the firmware from among the various firmware 105, and delivers it to the image forming apparatus 101.

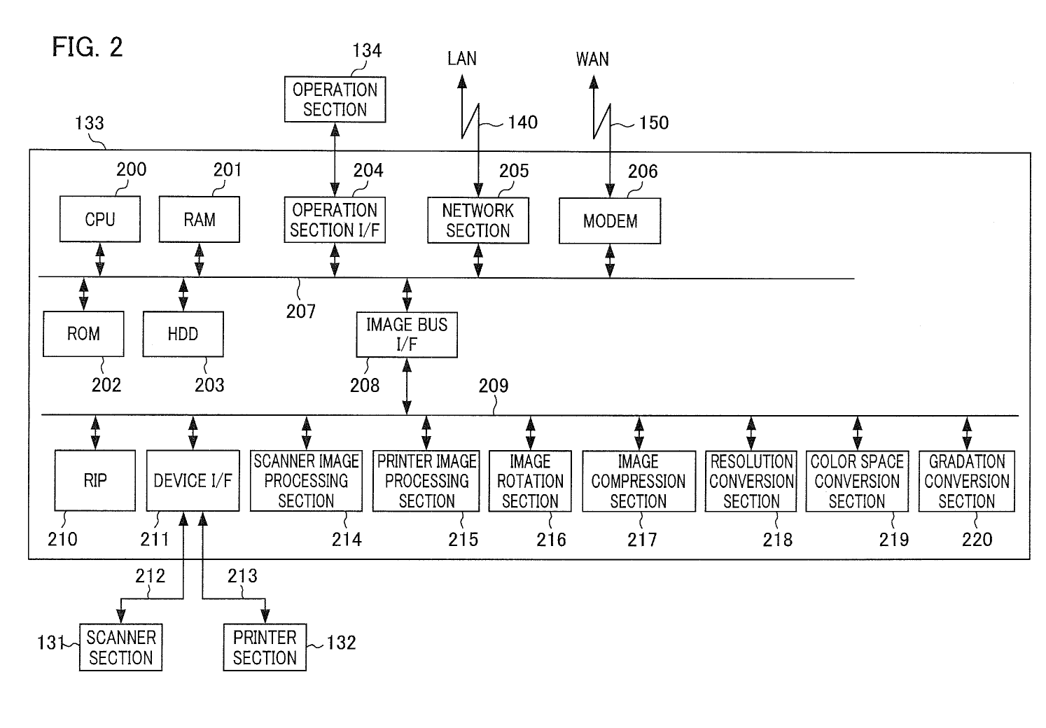

FIG. 2 is a diagram showing an exemplary hardware configuration of the image forming apparatus 101. The image forming apparatus 101 includes an operation section 134, a controller 133, a scanner section 131 for inputting an image, and a printer section 132 for outputting an image.

The controller 133 is connected to the scanner section 131 and the printer section 132, and is also connected to a network (LAN) 140 and a public network (WAN) 150. The controller 133 performs an input/output control for image information or device information.

The controller 133 includes a CPU 200, a RAM 201, a ROM 202, and a hard disk drive (hereinafter referred to as “HDD”) 203. The CPU 200 controls the entire system. The RAM 201 is a system working memory for the operation of the CPU 200, and is an image memory (buffer memory) for providing temporal storage of the input image data. The ROM 202 is a boot ROM, and firmware and a boot program are stored therein. The HDD 203 stores system software, image data, and the like.

The controller 133 further includes an operation section I/F 204, a network section 205, a modem 206, and a system bus 207. The operation section I/F 204 is an interface section with the operation section 134, and outputs image data or image data information to be displayed on the operation section 134 to the operation section 134. The operation section I/F 204 transmits information that has been input from the operation section 134 via an operator to the CPU 200. The network section 205 is connected to a network (LAN) 140 so as to input/output information. The modem 206 is connected to a public network (WAN) 150 so as to input/output image information. The system bus 207 connects the CPU 200 with the RAM 201, the ROM 202, the HDD 203, the operation section I/F 204, the network section 205, and the modem 206.

The controller 133 further includes an image bus I/F 208, an image bus 209, RIP (Raster Image Processor) 210, a device I/F 211, a scanner image processing section 214, and a printer image processing section 215. The image bus I/F 208 is a bus bridge that connects the system bus 207 with the image bus 209 which transfers image data at high speed so as to convert the data structure. The image bus 209 is composed of PCI bus or IEEE 1394.

A raster image processor (RIP) 210 develops PDL code into bitmap image. The device I/F 211 connects the scanner section 131 with the printer section 132 and the controller 133 via an image input section interface 212 and a print section interface 213 so as to carry out conversion of image data between synchronous and asynchronous systems. The scanner image processing section 214 performs correction, processing, and editing on the input image data. The scanner image processing section 214 determines from the chroma signal of the image whether the input image is a colored original document or a monochrome original document, and retains the results. The printer image processing section 215 performs correction, processing, and editing on the output image data.

The controller 133 further includes an image rotation section 216, an image compression section 217, a resolution conversion section 218, a color space conversion section 219, and a gradation conversion section 220. In conjunction with the scanner image processing section 214, the image rotation section 216 rotates an image while at the same time reading the image from the scanner section 131, and stores the resulting image in memory. The image rotation section 216 also rotates an image stored in memory, and stores the resulting image. The image rotation section 216 also rotates the image stored in memory in conjunction with the printer image processing section 215 and prints the resulting image.

The image compression section 217 performs JPEG compression and decompression processing on multi-level image data, and JBIG, MMR, MR, and MH compression and decompression processing on binary image data. The resolution conversion section 218 converts the resolution of the image stored in memory and stores the resulting image in memory. The color space conversion section 219 converts, for example, a YUV image stored in memory into a Lab image by matrix computation and stores the resulting image in memory. The gradation conversion section 220 converts, for example, an 8-bit, 256-gradation image stored in memory into a 1 bit binary image using a technique such as error-diffusion processing and stores the resulting image in memory.

The image rotation section 216, the image compression section 217, the resolution conversion section 218, the color space conversion section 219, and the gradation conversion section 220 can be linked to each other. When an image stored in memory is subjected to image rotation and resolution conversion, for example, both processes can be performed without any intervention of memory.

The image bus 209 is connected to the image bus I/F 208, the image bus 209, the RIP (raster image processor) 210, the device I/F 211, the scanner image processing section 214, and the printer image processing section 215. The image bus 209 is also connected to the image rotation section 216, the image compression section 217, the resolution conversion section 218, the color space conversion section 219, and the gradation conversion section 220.

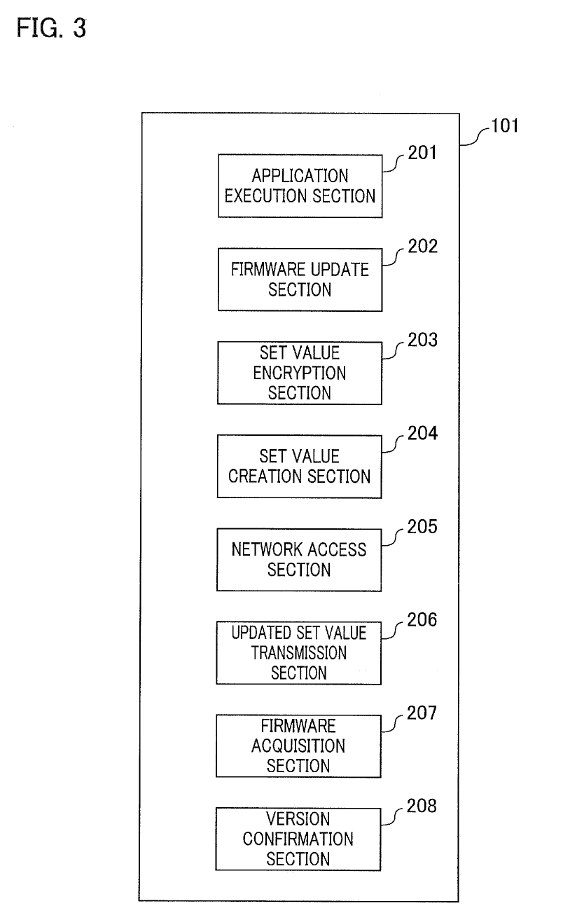

FIG. 3 is a diagram showing an example of the configuration of a computer program which performs a firmware update in the image forming apparatus 101.

The computer program of the image forming apparatus 101 includes an application execution section 201, a firmware update section 202, a set value encryption section 203, and a set value creation section 204. The computer program of the image forming apparatus 101 further includes a network access section 205, a set value transmission section 206, a firmware acquisition section 207, and a version confirmation section 208.

The application execution section 201 is an exemplary application execution unit. The firmware update section 202 is an exemplary firmware update unit. The set value encryption section 203 is an exemplary set value encryption unit. The set value creation section 204 is an exemplary set value creation section. The network access section 205 is an exemplary network access section. The set value transmission section 206 is an exemplary set value transmission unit. The firmware acquisition section 207 is an exemplary firmware setting unit. The version confirmation section 208 is an exemplary version confirmation section.

The application execution section 201 executes the application running using the firmware.

The firmware update section 202 starts a firmware update according to instructions from the delivery server 102, for example. The firmware update section 202 also decrypts encrypted set values and installs the new firmware.

The set value encryption section 203 acquires set values from the currently active firmware, and encrypts a personal information part that has been previously specified by the firmware designer. More specifically, the set value encryption section 203 partially encrypts a specific part from the acquired set values, for example, a set value such as personal information that is to be protected as confidential information.

In the following description, “personal information part” refers to a specific portion of the set values, for example, confidential information part such as personal information subjected to partial encryption.

The set value creation section 204 creates export data related to the set values used for firmware update based on the set values, which have been acquired by the set value encryption section 203, and personal information part, which have been encrypted by the section 203.

The network access section 205 accesses the network 103 and transmits and receives information.

The set value transmission section 206 transmits the update request, including a set value 104 and version information for the currently active firmware to be updated, to the delivery server 102.

The firmware acquisition section 207 acquires the new firmware from the delivery server 102, i.e., the new firmware for which a set value 106 has been set. A set value 105, in which personal information part has been encrypted, is set in the set new firmware.

The version confirmation section 208 confirms the version of the currently active firmware.

The respective sections of the computer system provided in the information processing apparatus 101 described above are achieved by the execution of the computer program stored in the HDD 203 and the ROM 202 by the CPU 200.

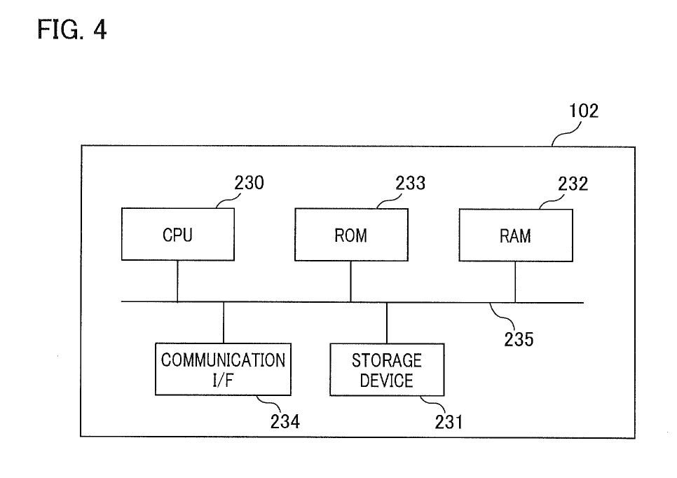

FIG. 4 is a diagram showing an example of the configuration of hardware of the delivery server 102. The delivery server 102 includes a CPU 230, a storage device 231, a ROM 232, a RAM 233, and a communication I/F 234. These components 230 to 233 are connected to a system bus 234.

The CPU 230 is the central processing unit, which loads software for updating firmware from the storage device 231 to a volatile memory 240, and then executes it.

The storage device 231 stores the firmware update processing software, the various firmware 105, and the model-specific old and new versions, and an example of which is a hard disk device.

The ROM 232 stores communication protocol information. The RAM 233 temporarily stores firmware updating software from the storage device 231 and stores data to be transmitted and received.

The communication I/F 234 is an interface for providing communication with the image forming apparatus 101 via the network 103.

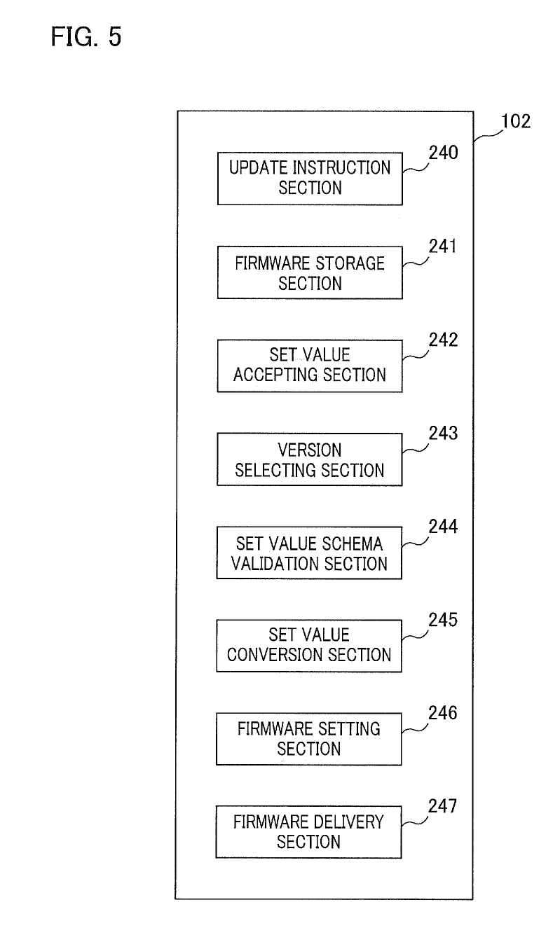

FIG. 5 is a diagram showing an example of the configuration of the computer program, which performs firmware delivery, of the delivery server 101.

The computer program that functions in the delivery server 102 is stored in the storage device 231. The delivery server 102 includes an update instruction section 240, a firmware storage section 241, a set value accepting section 242, a version selecting section 243, a set value schema validation section 244, a set value conversion section 245, a firmware setting section 246, and the firmware delivery section 247.

The update instruction section 240 is an exemplary update instruction section. The firmware storage section 241 is an exemplary firmware storing unit. The set value accepting section 242 is an exemplary set value converting unit. The version selecting section 243 is an exemplary version selecting unit. The set value schema validation section 244 is an exemplary set value schema validation unit. The set value conversion section 245 is an exemplary set value converting unit. The firmware setting section 246 is an exemplary firmware setting unit. The firmware delivery section 247 is an exemplary firmware delivering unit.

The update instruction section 240 provides firmware update instructions to the image forming apparatus 101 when the new firmware is released.

The firmware storage section 241 stores the model-specific and the old and new version firmware 105 and manages the various firmware 105 by using a database.

The set value accepting section 242 accepts an update request from the image forming apparatus the set value 104 required for firmware updating and version information of the currently active firmware to be updated.

The version selecting section 243 analyzes the content of request accepted by the set value accepting section 242. The version selecting section 243 searches the database managed by the firmware storage section 241 based on the analysis result and selects an appropriate version firmware from among the various firmware 105.

The set value schema validation section 244 authorizes a set value schema.

The set value conversion section 245 converts the set value 104 in the update request that has been accepted by the set value accepting section 242 so as to be compatible with the new firmware that has been selected by the version selecting section 243. In this case, the encrypted personal information part remains encrypted.

The firmware setting section 246 sets the set value 105, which has been appropriately converted by the set value conversion section 245, to the new firmware that has been selected by the version selecting section 243.

The firmware delivery section 247 delivers the new firmware for which the setting process has been finished by the firmware setting section 246 to the image forming apparatus 101 that has transmitted an update request.

Among the respective sections of the computer program provided in the delivery server 102 described above, the respective sections other than the firmware storage section 241 are achieved by the execution of the computer program for implementing the respective functions by the CPU 230. A firmware storage section is implemented by the storage device 231 such as a hard disk.

(Firmware Update Processing Performed by Image Forming Apparatus)

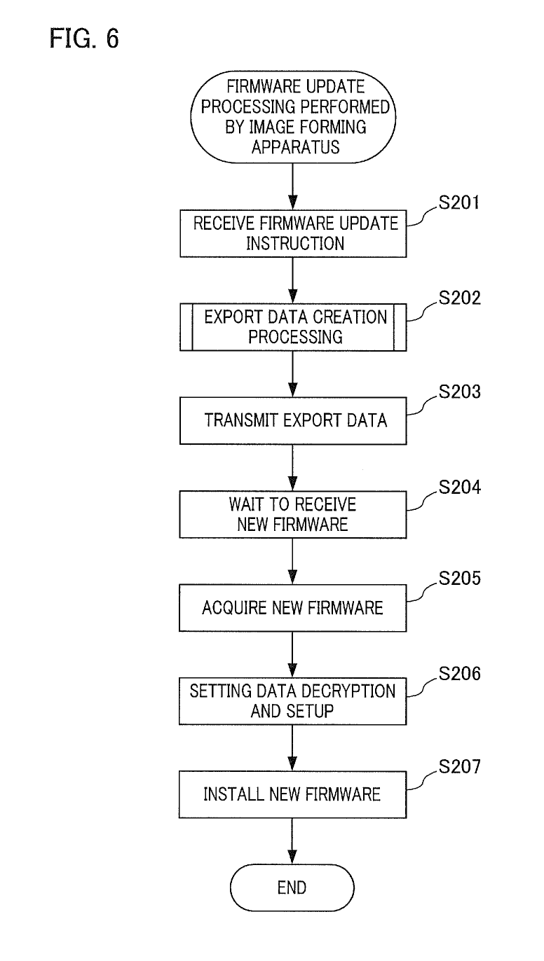

FIG. 6 is a flowchart showing the procedure of firmware update processing performed by the image forming apparatus 101.

The firmware update section 202 provided in the image forming apparatus 101 waits to receive an update instruction from the delivery server 102 and starts firmware update processing after the reception of the instruction (step S201).

In the first embodiment, the update is started by an instruction from the delivery server 102. However, the update may be started by an instruction from a server other than the delivery server. For example, a monitoring server that monitors the image forming apparatus 101 may provide instructions.

The image forming apparatus 101 starts firmware update processing performed by the firmware update section 202 according to the instructions from the delivery server 102.

Then, the set value encryption section 203 in the image forming apparatus 101 acquires set values to be used for updating from the currently active firmware. The set value encryption section 203 also encrypts a personal information part that has been previously specified by the firmware designer and creates export data related to the set values to be used for firmware updating (step S202).

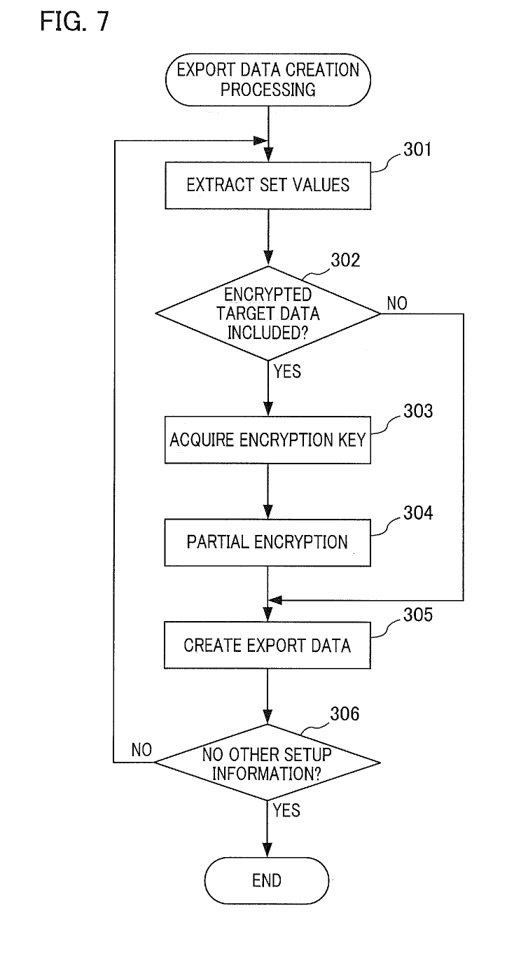

The export data creation processing will be described below with reference to the flowchart in FIG. 7.

The set value transmission section 206 transmits export data that has been created by the set value encryption section 203 in step S202, i.e., the partially encrypted set value 104 to the delivery server 102 via the network 103. The set value transmission section 206 simultaneously transmits the version information for the currently active firmware to be updated (step S203).

After the completion of step S203, the image forming apparatus 101 waits for the download of the new firmware from the delivery server 102 (step S204).

The firmware acquisition section 207 acquires the new firmware from the delivery server 102 when the firmware acquisition section 207 receives notification from the delivery server 102 that the new firmware is downloadable (step S205).

In the new firmware that has been acquired by the firmware acquisition section 207, the encrypted set value 106 of personal information that has been created by the image forming apparatus 101 in step S202, is set.

A firmware update section 201 decrypts the encrypted set value 106 using the same key as that is used for encryption in step S202 and resets the value (step S206).

Next, the firmware update section 201 installs the new firmware which has been reset by the decrypted set value (step S207). New firmware installation is performed by the writing of the new firmware to the ROM 202 by the firmware update program running on the RAM 201. After the new firmware has been written, the image forming apparatus 101 is reactivated and operated by the new firmware.

(Export Data Creation Processing)

FIG. 7 is a flowchart showing export data creation processing of the set values performed by the image forming apparatus 101.

First, the set value encryption section 203 acquires the set values from the currently active firmware (step S301).

In the following explanation, the set value encryption section 203 executes encryption processing based on W3C XML Encryption Requirements (XML encryption specification).

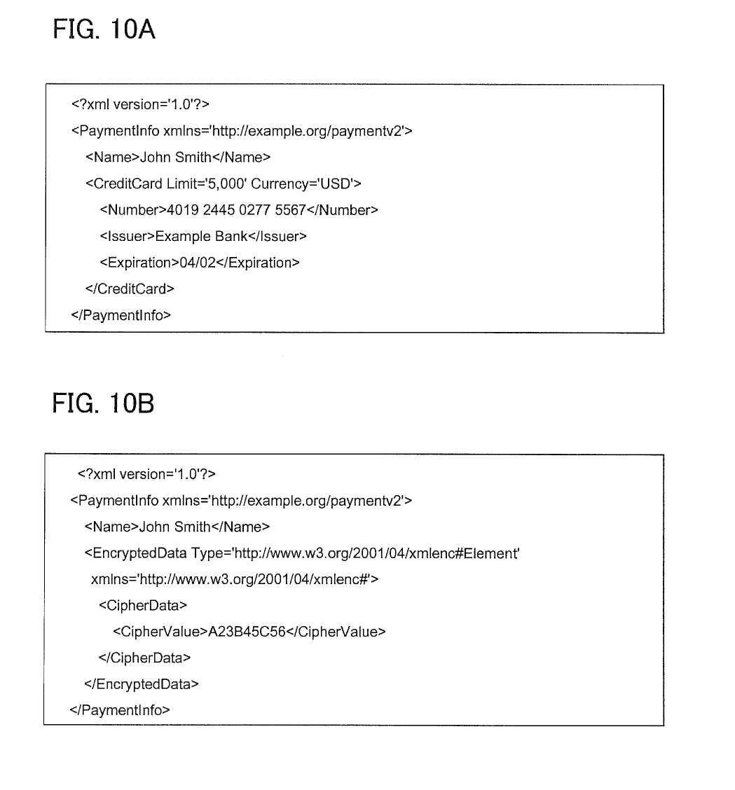

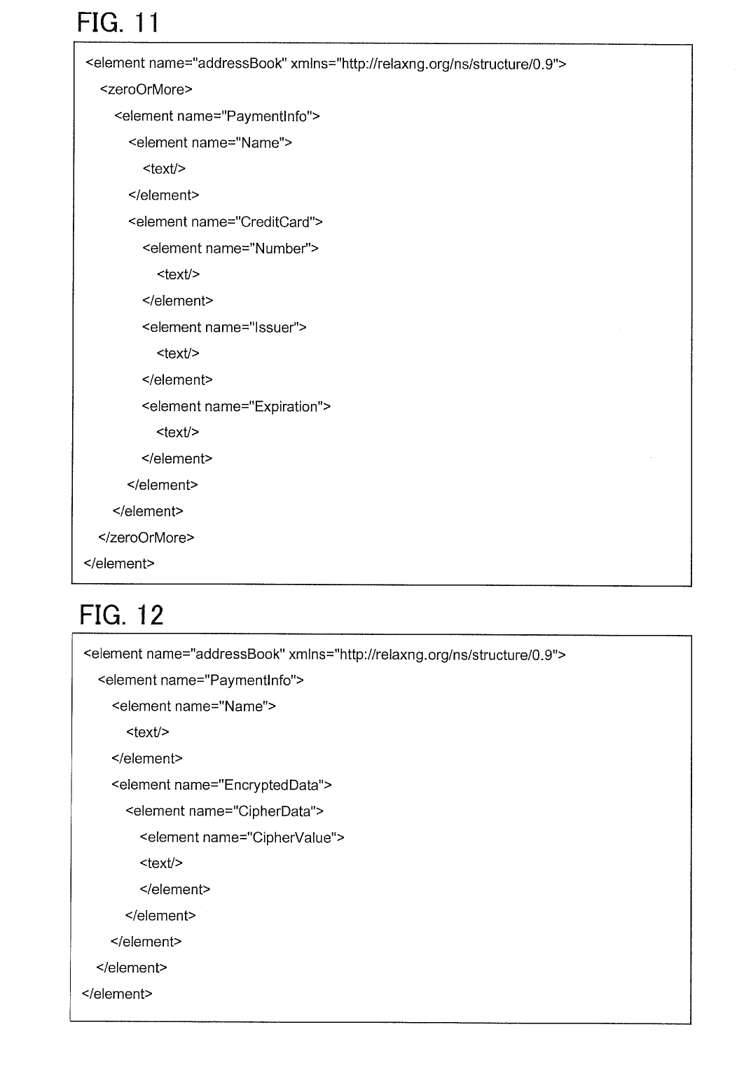

The set values are described, by way of example, as an XML (eXtensible Markup Language) document as shown in FIG. 10. Also, the currently active firmware has a schema as shown in FIG. 11.

Based on the schema, settable attributes such as Name, CreditCard, Number, Issuer, and Expiration are set. The attribute to be encrypted is predetermined by the firmware designer and is set in the set value encryption section 203 in the image forming apparatus 101. In this example, CreditCard, Number, Issuer, and Expiration are set as attributes to be encrypted.

The set value encryption section 203 sequentially reads the set values that have been acquired in step S301 and determines whether or not data to be encrypted is included for each XML attribute (step S302).

When the set value encryption section 203 has determined in step S302 that the read XML attribute data is the attribute data to be encrypted, the set value encryption section 203 acquires a device-specific encryption key that is separately pre-stored by the image forming apparatus 101 (step S303).

The set value encryption section 203 encrypts the XML attribute data that has been determined in step S302 using the acquired encryption key (step S304). The set value encryption section 203 does not encrypt the XML attribute data that does not include data to be encrypted and leaves the data as is.

For example, in the XML document shown in FIG. 10(a), the set values for the attributes described as CreditCard, Number, Issuer, and Expiration are encrypted as shown in FIG. 10(b). The set value for the attribute described as Name is not encrypted and the data is left as is.

A set value creation section 203 stores data that include both the encrypted set values and the unencrypted set values as export data (step S305).

The set value encryption section 203 determines whether or not there is any other set value (step S306). In step S306, the process returns to step S301 described above if there is any other set value, whereas the process ends if there is no other set value.

(Delivery Server Update Processing)

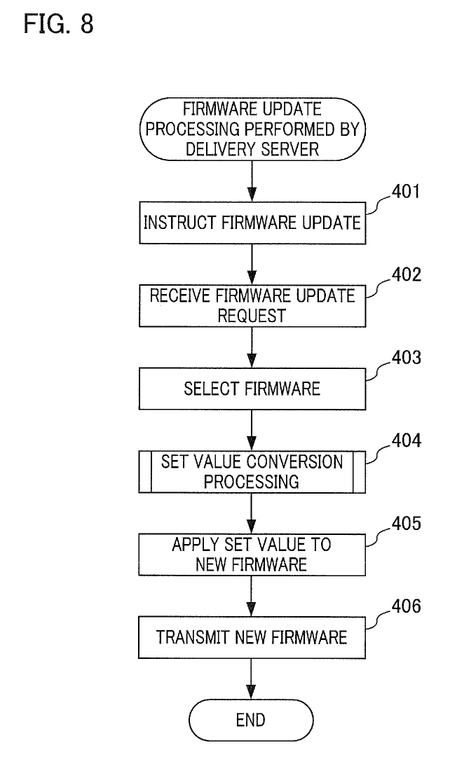

FIG. 8 is a flowchart showing the procedure of firmware update processing performed by the delivery server 102.

The update instruction section 240 in the delivery server 102 transmits an update instruction to the image forming apparatus 101 (step S401). The firmware storage section 241 stores the model-specific and the old and new version of the firmware in a database. The update instruction section 240 refers to the database when the new firmware is released and provides update instructions to the image forming apparatus 101 that has been preset as the delivery destination.

After the provision of an update instruction to the image forming apparatus 101 in step S401, the delivery server 102 waits for an update request from the image forming apparatus 101.

The set value accepting section 242 receives the update request from the image forming apparatus 101 (step S402). The contents of the update request from the image forming apparatus 101 include both the set values 104 and the version information of the firmware currently operating on the image forming apparatus 101. The set values 104 include both the encrypted set values and the unencrypted set values.

The version selecting section 243 analyzes the content of the firmware update request that has been accepted by the set value accepting section 242. The version selecting section 243 searches the database managed by the firmware storage section based on the analysis result and selects the appropriate version of firmware (step S403).

The set value conversion section 245 converts the set value 104 included in the update request accepted by the set value accepting section 242 in step S402 so as to be compatible with the selected new firmware (step S404).

The firmware setting section 246 sets the set value 104 that has been converted in step S404 to the new firmware (step S405).

The firmware delivery section 247 delivers the new firmware to the image forming apparatus 101 (step S406).

(Set Value Conversion Processing)

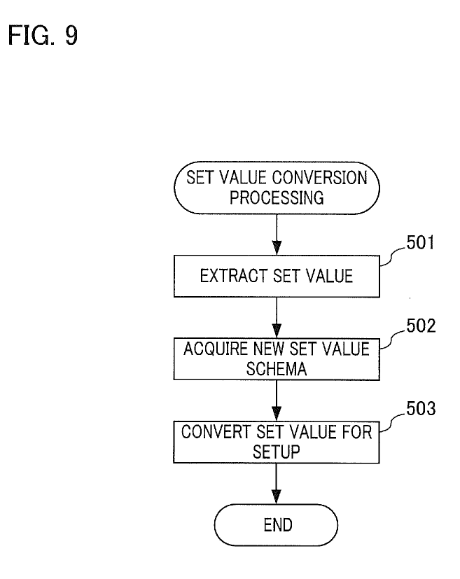

FIG. 9 is a flowchart showing the procedure of set value conversion processing performed by the delivery server 102.

The set value conversion section 245 extracts the set values from the update request that has been received by the image forming apparatus 101 (step S501).

The set value conversion section 245 acquires a new schema for setting the set values of the new firmware that has been selected by the version selecting section 243 in step S403 (step S502).

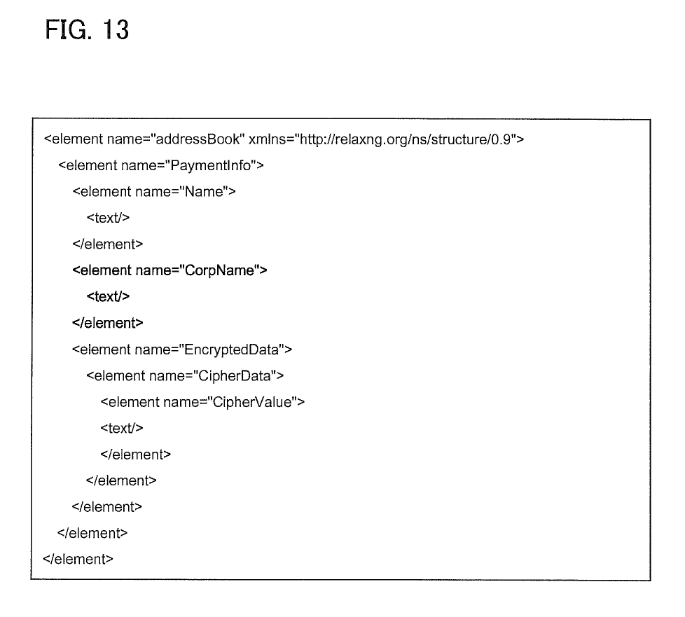

FIG. 13 is a diagram showing an example of the new schema. In the new schema, the portion <element name=“CorpName”> is extended as a newly settable item in the new firmware relative to the old schema shown in FIG. 12.

The set value conversion section 245 converts the set values that have been acquired from the image forming apparatus 101 based on the extended schema and sets them to the new firmware (step S503).

More specifically, the set value conversion section 245 sets the encrypted set values (i.e., EncryptedData, CipherData, and CipherValue) and the unencrypted set value (i.e., Name) based on the new schema shown in FIG. 13. Additionally, the set value conversion section 245 sets the null character sequence or the character sequence predetermined by the designer of the new firmware to the extended setting items <element name=“CorpName”>.

As explained in the foregoing, the set value conversion section 245 converts the set values so as to be compatible with the new firmware. When the set value conversion section 245 converts the set values, the encrypted personal information part remains encrypted and is set to the new firmware as is.

Also, the set value conversion section 245 converts the set values so as to be compatible with the new firmware. For example, in the old firmware, the storage location of the history file for print jobs is /var/log/jobRecord.log. The set value conversion section 245 automatically converts this to the new storage location (/local/var/log/jobRecord.log). In other words, the set value conversion section 245 changes a directory for placing the set values to be managed under the control of firmware based on the predetermined rule, and the firmware setting section thereby sets the set values.

As described above, the first embodiment produces the following effects.

(1) When the firmware of the image forming apparatus is updated, the setup information of the current firmware can be automatically inherited by the new firmware without requiring manual resetting.

(2) When the image forming apparatus transmits the setup information to the delivery server, a portion of the setup information such as personal information is encrypted using an encryption key specific to the image forming apparatus. Hence, even if the setup information is read from the delivery server, the encrypted personal information is not decrypted, and the disclosure of personal information can thereby be avoided.

(3) Since the delivery server delivers the new firmware in which the set values are set to the image forming apparatus, the image forming apparatus can install the new firmware in which the set values are reliably taken over.

Firmware in the image forming apparatus (Multi Functional Printer) may either be automatically upgraded by a content delivery server or be manually upgraded by service personnel. In such cases, a safe transition of the various set values (such as user information, network setup information) in the image forming apparatus is required.

More specifically, for a firmware version upgrade, various changes in various set values for the image forming apparatus such as a partition change for a hard disk, a schema change for the database, a schema expansion for the set values may be required because of function expansion or corrective maintenance.

When an MFP firmware version upgrade associated with a change of various set values is performed, it is preferable that the conversion of various set values associated with a storage location change or a schema change be performed automatically while keeping the integrity of various set values. In addition, when the firmware version is upgraded, it is required that the version upgrade is executed in a safe manner so as not to disclose personal information among various set values.

In the system of the present embodiment, described above, new firmware can take over various set values from the currently active firmware in a safe and automatic manner. Therefore, in the present embodiment, the firmware delivery server can convert various set values so as to be compatible with the new firmware. In addition, in the system of the present embodiment, the protection of personal information associated with a firmware version upgrade is sufficient.

Next, the firmware updating system according to the second embodiment of the present invention will be described.

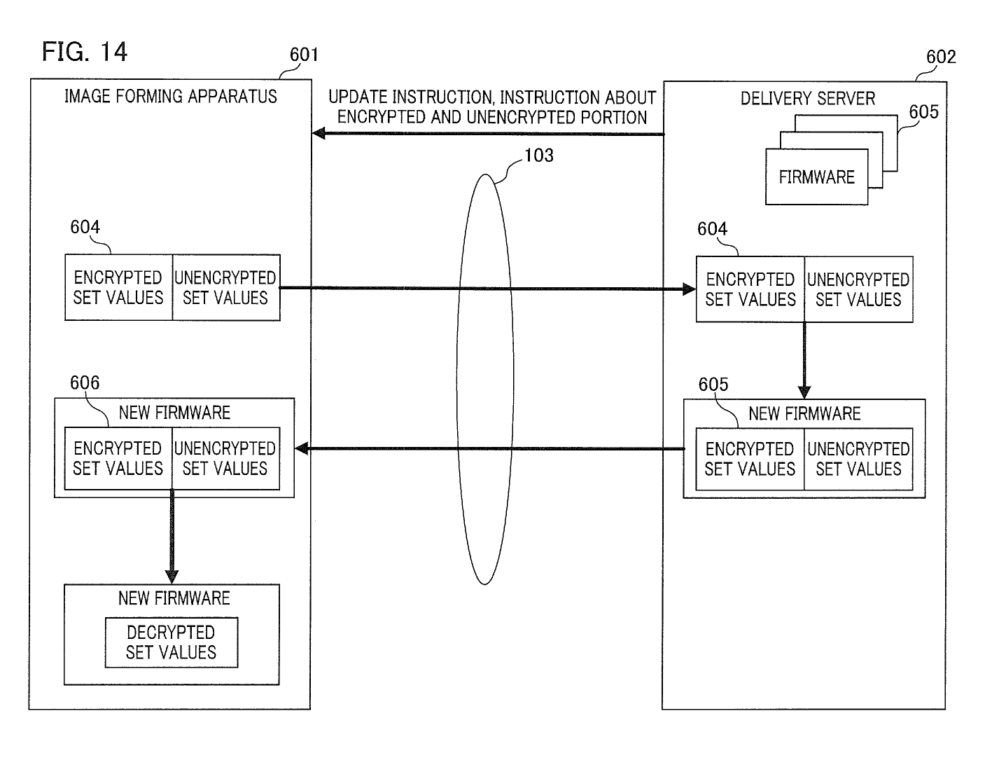

FIG. 14 is a diagram showing an example of the configuration of the firmware updating system according to the second embodiment. In the first embodiment, a portion to be encrypted among the set values is beforehand specified. The second embodiment is the same as the first embodiment except that a delivery server 602 provides instructions about a portion to be encrypted and a portion not to be encrypted to an image forming apparatus 601 as shown in FIG. 14.

The image forming apparatus 602, which is an example of an image forming apparatus that stores the firmware according to the second embodiment, has the same configuration of the hardware and the computer program as those in the first embodiment, and all of these are designated by the same reference numerals and no further description will be given here.

The delivery server 602, which delivers the firmware according to the second embodiment, has the same configuration of the hardware and the computer program as those of the delivery server 102 according to the first embodiment, and all of these are designated by the same reference numerals and no further description will be given here.

(Firmware Update Processing by Image Forming Apparatus)

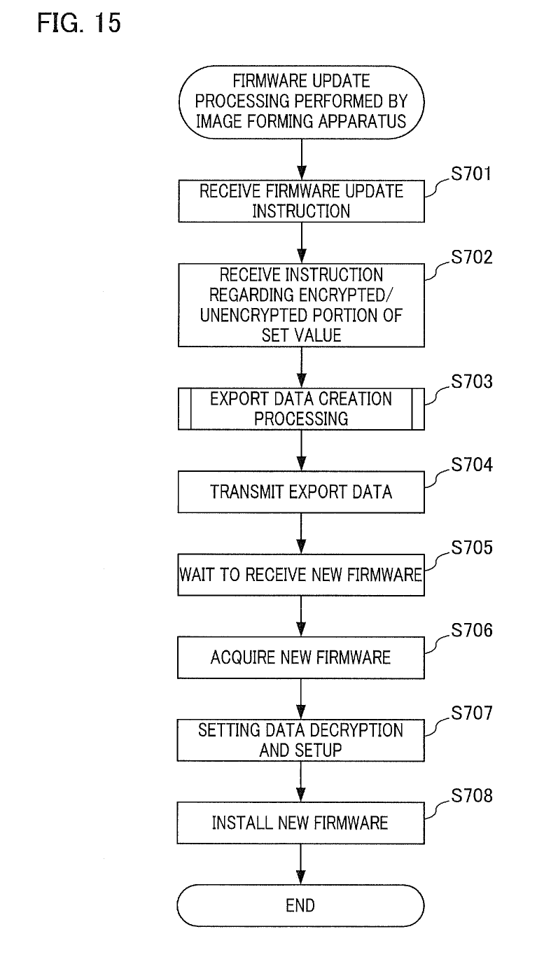

FIG. 15 is a flowchart showing the procedure of firmware update processing performed by the image forming apparatus 601 according to the second embodiment.

The firmware update section 202 on the image forming apparatus 601 waits to receive an update instruction from the delivery server 602 and starts firmware update processing after the reception of the instruction (step S701).

In the second embodiment, the delivery server 602 designates an encrypted portion and an unencrypted portion among the set values of the firmware to be updated. In other words, since the set values have the XML document structure, the delivery server 602 provides instructions about the XML tag for an encrypted portion and the XML tag for an unencrypted portion.

In step S702, the image forming apparatus 601 receives instructions about an encrypted portion and an unencrypted portion (instruction about the XML tag for an encrypted portion and the XML tag for an unencrypted portion) among the set values of the firmware to be updated from the delivery server 602 (step S702).

Next, the set value encryption section 203 also encrypts a portion to be encrypted as instructed by the delivery server 602 and creates export data related to the set values used for firmware updating (step 703).

As the following processes from step S704 to S708 are the same as those from step 203 to S207 in the first embodiment shown in FIG. 6, no further description will be given here.

As the processes for creating export data of the set values according to the second embodiment are the same as those in the first embodiment shown in FIG. 7, no further description will be given here.

(Delivery Server Update Processing)

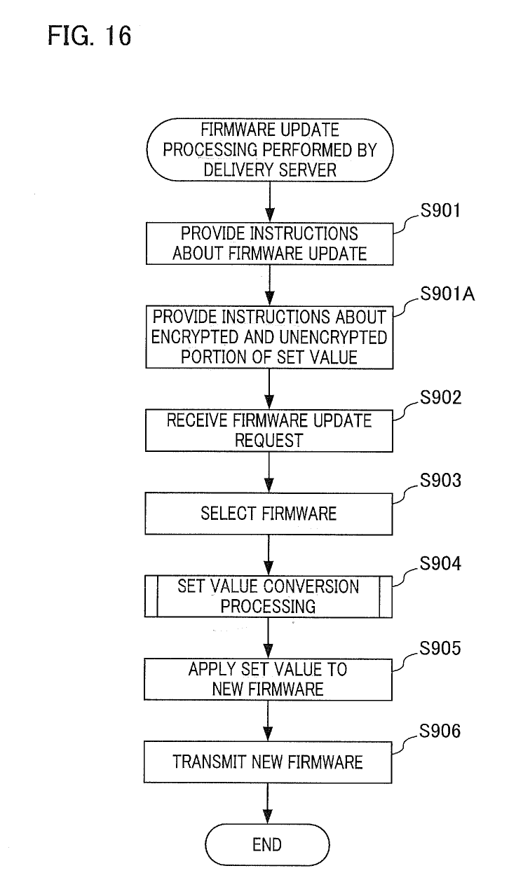

FIG. 16 is a flowchart showing the procedure of firmware update processing performed by the delivery server 602.

The update instruction section 240 in the delivery server 602 transmits an update instruction to the image forming apparatus 101 (step S401).

In the second embodiment, the update instruction section 240 transmits an instruction for specifying an encrypted portion and an unencrypted portion among the set values of the firmware to be updated to the image forming apparatus 101. More specifically, the delivery server 602 provides instructions about the XML tag for a portion to be encrypted and the XML tag for a portion to be unencrypted (step S901A).

Hereinafter, the processes from step S903 to S906 are the same as those from step S403 to S406 in the first embodiment shown in FIG. 8.

Set value conversion processing performed by the delivery server 602 is also the same as the corresponding steps in the first embodiment shown in FIG. 9.

As described above, the second embodiment provides the same effects (1) to (3) as those of the first embodiment described above. Furthermore, in the second embodiment, the delivery server instructs the image forming apparatus about a portion to be encrypted and a portion not to be encrypted among the set values to be set in the firmware, and the disclosure of personal information can thereby be reliably avoided.

Next, the firmware updating system according to the third embodiment of the present invention will be described.

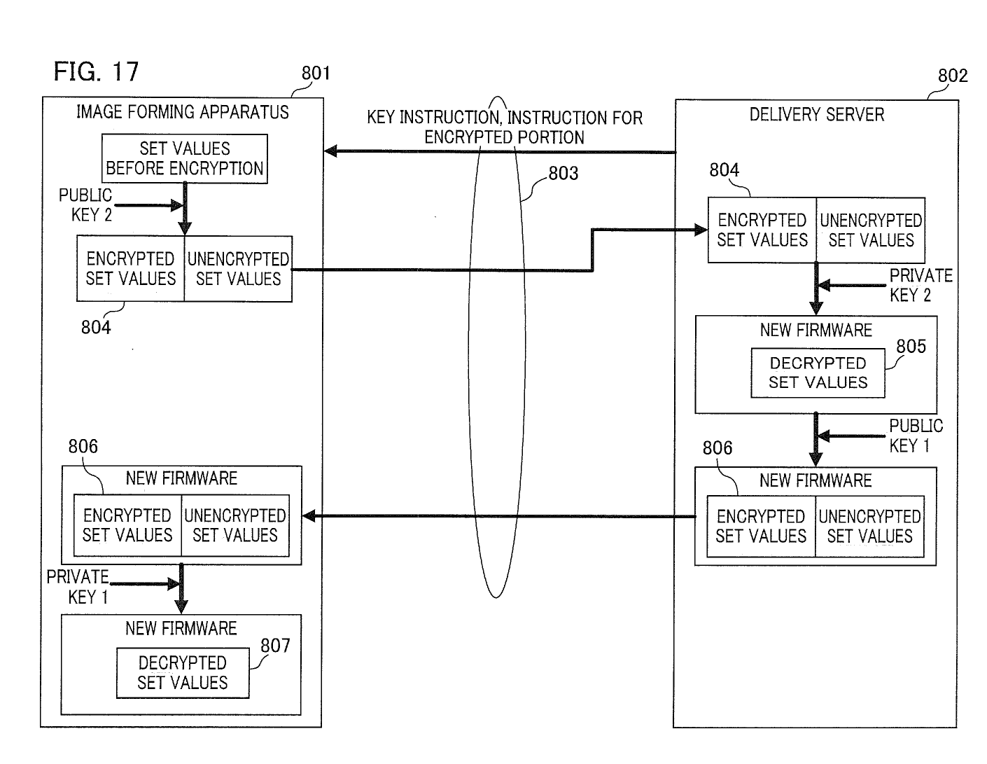

FIG. 17 is a diagram showing an example of the configuration of the firmware updating system according to the third embodiment.

In the first embodiment, the partial encryption of the set values is performed using an encryption key specific to the image forming apparatus. The third embodiment is the same as the first embodiment except that an image forming apparatus 801 and a delivery server 802 hold a shared private key and public key and encrypt the set values using common keys as shown in FIG. 17.

The image forming apparatus according to the second embodiment has the same configuration of the hardware and the computer program as those in the first embodiment except that the image forming apparatus holds a private key 801 and a public key 2 as shown in FIG. 17, and all of which are designated by the same reference numerals and no further description will be given here.

The delivery server according to the second embodiment has the same configuration of the hardware and the computer program as those of the delivery server according to the first embodiment except that the delivery server holds a private key 2 and a public key 1 as shown in FIG. 17, and all of these are designated by the same reference numerals and no further description will be given here. Note that the private key 1 and the public key 1 are in pairs, and the private key 2 and the public key 2 are in pairs.

(Firmware Update Processing by Image Forming Apparatus)

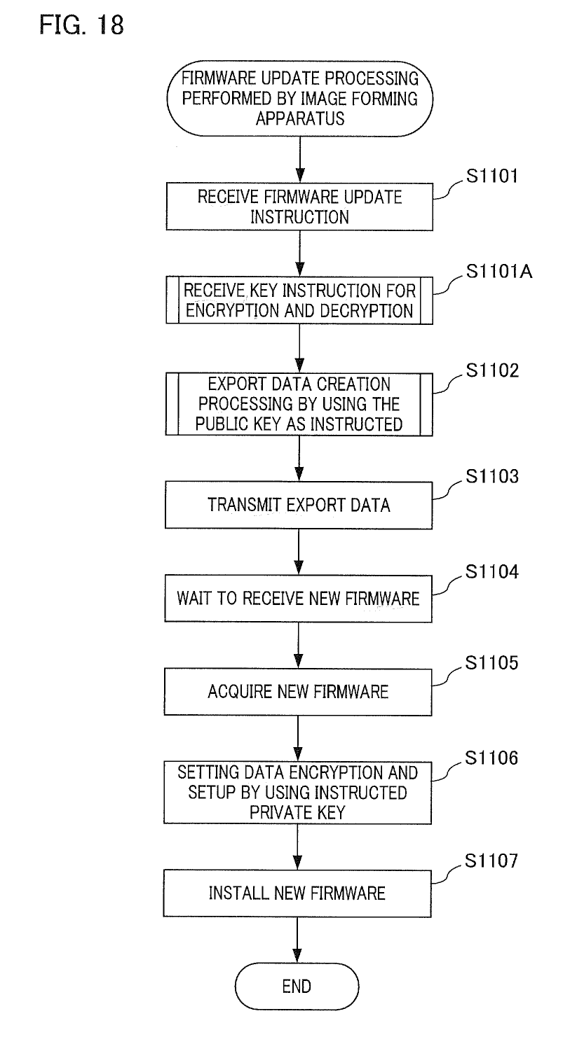

FIG. 18 is a flowchart showing the procedure of firmware update processing performed by the image forming apparatus 801 according to the third embodiment.

The firmware update section 202 provided in the image forming apparatus 801 waits to receive an update instruction from the delivery server 102 and starts firmware update processing after the reception of the instruction (step S1101).

Next, the firmware update section 202 receives an instruction both for a public key used for encryption of the set values and for a private key used for decryption of the set values from the delivery server 802 (step S1101A). In FIG. 17, the delivery server 802 specifies the public key 2.

The set value encryption section 203 also encrypts a portion to be encrypted using the public key 2 as instructed by the delivery server 102 and creates export data related to the set values used for firmware updating (step S1103). In the third embodiment, the set values not to be encrypted remain unencrypted. A portion to be encrypted and a portion not to be encrypted may be specified beforehand as in the first embodiment, or instructions therefore may be provided by the delivery server 802 as in the second embodiment.

The set value transmission section 206 transmits export data, i.e., a partially encrypted set value 804 to the delivery server 802 via the network 103. The set value transmission section 206 simultaneously transmits version information of the currently active firmware to be updated (step S1103).

After the completion of step S1103, the image forming apparatus 101 waits for a download of the new firmware from the delivery server 102 (step S1104).

The firmware acquisition section 207 acquires the new firmware from the delivery server 802 when the firmware acquisition section 207 receives notification from the delivery server 802 that the new firmware is downloadable (step S1105).

In the new firmware that has been acquired by the firmware acquisition section 207, the set value 806 is set wherein personal information created by the image forming apparatus 801 in step S1102 has been encrypted.

The firmware update section 201 decrypts the encrypted set value 106 using the private key 1 as instructed by the delivery server 802 in step S1101A and resets the resulting value (step S1106).

Next, the firmware update section 201 installs the new firmware in which the decrypted set value 807 has been reset (step S1107).

As the processes of creating export data of the set values according to the second embodiment is the same as those in the first embodiment shown in FIG. 7, no further description will be given here.

(Delivery Server Update Processing)

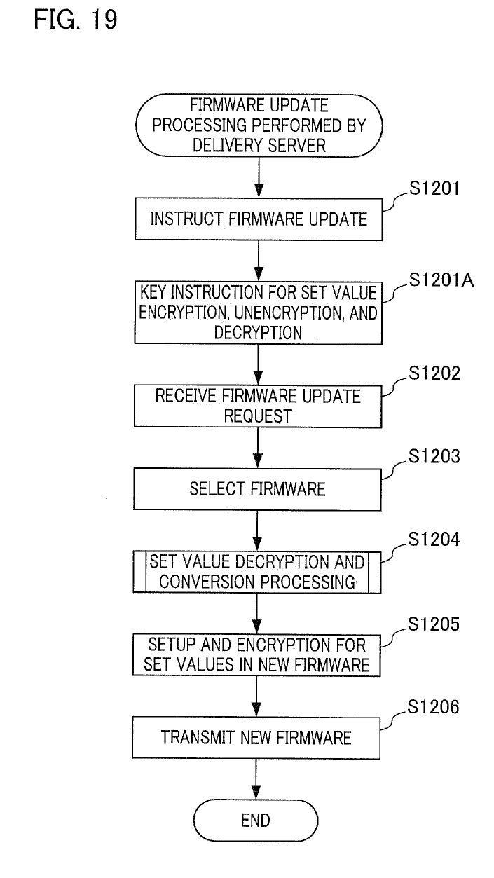

FIG. 19 is a flowchart showing the procedure of firmware update processing performed by the delivery server 802.

The update instruction section 240 in the delivery server 802 transmits an update instruction to the image forming apparatus 101 (step S1201).

Next, the update instruction section 240 provides instructions about a key for encrypting and decrypting the set values of the firmware to be updated (step S1201A).

After the provision of an update instruction to the image forming apparatus 801 in step S1201A, the delivery server 102 waits for an update request from the image forming apparatus 801.

The set value accepting section 242 receives the update request from the image forming apparatus 801 (step S1202).

The version selecting section 243 selects the appropriate version of the firmware (step S1203).

The set value conversion section 245 decrypts an encrypted set value 804 using the private key 2 corresponding to the public key 2 and converts the resulting value so as to be compatible with the new firmware (step S1204).

The firmware setting section 246 sets the set value 104 that has been converted in step S404 to the new firmware and encrypts it using the public key 1 (step S1205).

The firmware delivery section 247 delivers the new firmware to the image forming apparatus 101 (step S1206).

Set value conversion processing performed by the delivery server 802 is the same as the corresponding steps in the first embodiment shown in FIG. 9.

The present invention can be realized by recording a computer program which realizes the present invention onto a computer readable recording medium, and causing each of the computers to read the computer program recorded onto the recording medium for execution. That is, the computer program itself for implementing the functional processing of the present invention is also included in the present invention.

As described above, the third embodiment provides the same effects (1) to (3) as those of the first embodiment described above. Furthermore, in the third embodiment, the encryption of the set values is performed using a public key and a private key, and the delivery server provides instructions about keys for use. Consequently, a higher level encryption is performed, whereby the disclosure of personal information can be avoided.

While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-256012 filed Oct. 1, 2008 which is hereby incorporated by reference herein in its entirety.

What is claimed is:

1. An image forming apparatus that receives a firmware from a delivery server and installs the firmware, the image forming apparatus comprising:
a set value encryption unit configured to acquire set values which have been set in the current firmware and encrypt a part of the set values;
a set value transmission unit configured to transmit an encrypted set value and an unencrypted set value to the delivery server;
a firmware acquisition unit configured to acquire the new firmware, in which the encrypted set value and the unencrypted set value have been set, from the delivery server;
a firmware update unit configured to decrypt the encrypted set value and install the new firmware; and
an accepting unit configured to receive instructions about the set value to be encrypted among the set values from the delivery server.

2. The image forming apparatus according to claim 1, wherein among the set values, a set value to be encrypted is specified beforehand.

3. The image forming apparatus according to claim 1, wherein the instructions about a key to encrypt or decrypt the set values is received from the delivery server.

4. A delivery server for delivering a firmware to an image forming apparatus, the delivery server comprising:
a firmware storing unit configured to store a firmware;
a set value accepting unit configured to accept encrypted set values and unencrypted set values from the image forming apparatus;
a set value converting unit configured to convert the set values so as to be compatible with the new firmware;
a firmware setting unit configured to set the set values which have been converted by the set value converting unit in the new firmware;
a firmware delivering unit configured to deliver the new firmware, in which the set values have been set by the firmware setting unit, to the image forming apparatus; and
an update instructing unit configured to provide instructions about the set value to be encrypted among the set values to the image forming apparatus.

5. The delivery server according to claim 4, wherein among the set values, the image forming apparatus is instructed about a set value to be encrypted.

6. The delivery server according to claim 4, wherein the set value converting unit causes the firmware setting unit to set the set values by changing a directory for positioning the set values, which are managed under the control of firmware, based on a predetermined rule.

7. A firmware updating method that delivers firmware from a delivery server and updates the firmware of an image forming apparatus, the firmware updating method comprising the steps of:
receiving instructions about the set value to be encrypted among the set values from the delivery server by the set value encryption unit of the image forming apparatus;
acquiring set values which have been set in current firmware and encrypting a part of the set values by the set value encryption unit of the image forming apparatus;
transmitting an encrypted set value and an unencrypted set value to the delivery server by the set value transmission unit of the image forming apparatus;
accepting the encrypted set value and the unencrypted set value from the image forming apparatus by the set value accepting unit of the delivery server;
converting the set values so as to be compatible with the new firmware by the set value converting unit of the delivery server;
setting the set values, which have been converted by the set value converting unit to the new firmware, by the firmware setting unit of the delivery server; and
delivering the new firmware, in which the set values have been set by the firmware setting unit, to the image forming apparatus by the firmware delivering unit of the delivery server.

8. A method for receiving firmware from a delivery server and installing the firmware, the method comprising:
a set value encryption step of acquiring set values which have been set in the current firmware and encrypting a part of the set values;
a set value transmission step of transmitting an encrypted set value and an unencrypted set value to the delivery server;
a firmware acquisition step of acquiring the new firmware, in which the encrypted set value and the unencrypted set value have been set, from the delivery server;
a firmware update step of decrypting the encrypted set value and installing the new firmware; and
an accepting step of receiving instructions about the set value to be encrypted among the set values from the delivery server.

9. A method for delivering a firmware to an image forming apparatus, the method comprising:
a firmware storing step of storing firmware;
a set value accepting step of accepting encrypted set values and unencrypted set values from the image forming apparatus;
a set value converting step of converting the set values so as to be compatible with the new firmware;
a firmware setting step of setting the set values which have been converted by the set value converting unit to the new firmware;
a firmware delivering step of delivering the new firmware, in which the set values have been set by the firmware setting unit, to the image forming apparatus; and
an update instructing step of providing instructions about the set value to be encrypted among the set values to the image forming apparatus.
